(19) United States
(12) Patent Application Publication
(10) Pub. No.: US 2005/0162521 A1
(43) Pub. Date: Jul. 28, 2005

(54) Portable terminal having imaging function

(75) Inventors: Mitsuhiro Nishizono, Kanagawa (JP); Yuji Ishida, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/045,778

(22) Filed: Jan. 27, 2005

(30) Foreign Application Priority Data
Jan. 28, 2004 (JP) P2004-019771

(51) Int. Cl. H04N 5/225

(52) U.S. Cl. 348/207.99

(57) ABSTRACT

A portable terminal having an imaging function involves a first housing, a second housing coupled with the first housing rotatably through a coupling section so that the first housing and the second housing overlap one another in a direction of thickness of the first housing and the second housing, a communication section, an imaging section, and a light emitting section that emits light for supplementing imaging by the imaging section, a radio antenna disposed in the first housing, a capacitor that is disposed in the second housing and supplies power to the light emitting section, and a charging section that is disposed in the second housing and charges the capacitor, wherein the charging section and the radio antenna section are positioned not to face one another in a direction of thickness of the first housing and the second housing when the first housing and the second housing overlap one another.

### BACKGROUND OF THE INVENTION

1. Field of the Invention

The present invention relates to a portable terminal having an imaging function, and more specifically, to a portable terminal having a light emitting section (strobe) with a xenon discharge tube, with a communication function and an imaging function.

2. Description of the Related Art

In the prior arts, an imaging device having an imaging section with a CCD (charge-coupled device) or the like and a light emitting section (strobe) using a xenon discharge tube, which are disposed within the same housing, is known. In such an imaging device, internal electronic circuits are configured such that light from the light emitting section is emitted during imaging operation.

The xenon discharge tube used in the light emitting section of the imaging device or the like generally requires high voltage. For this reason, voltage is not directly fed from a battery having a low voltage, but from a capacitor to the xenon discharge tube. Here, the capacitor is charged by means of a charging section (DC-DC converter) at a predetermined time prior to the imaging.

In the portable terminal having a communication function which gets connected to the imaging device having the light emitting section, image captured by the imaging device is transmitted to the portable terminal. In this case, however, when the capacitor in the imaging device is charged, electrical noise is generated from the charging section. As a result, the communication function of the portable terminal is affected by the electrical noise to be erroneously operated. For this reason, an imaging device which, when detecting that the portable terminal is connected, can stop the operation of the light emitting section and charging of the capacitor by the charging section has been suggested (for example, see JP-A-2003-69890).

Meanwhile, like the portable terminal having the imaging function, a portable terminal having both a communication function and an imaging function is known. Such a portable terminal having the imaging function has been subject to the request that the light emitting section such as the xenon discharge tube or the like is provided and integrated into the housing.

JP-A-2003-69890 is referred to as a related art.

However, in the case that the light emitting section such as the xenon discharge tube is provided in a portable terminal having both the communication function and the imaging function, the communication function may be affected by the electrical noise generated during the charging of the capacitor leading to such errors as malfunction of the terminal and noise mixed into voice.

Further, in order to avoid the erroneous operation of the communication function, the potable terminal may be configured not to use the communication function during the charging of the capacitor. Nevertheless, if an incoming call is received, the communication function may be affected by the electrical noise generated from the charging section leading to the above mentioned errors.

### SUMMARY OF THE INVENTION

An object of the present invention is to provide a portable terminal which can reduce the effect from electrical noise generated in a charging section used for charging a capacitor of a light emitting section and which can prevent a communication function of the portable terminal from erroneously operating.

The invention provides a portable terminal having an imaging function, having: a first housing; a second housing coupled with the first housing rotatably through a coupling section so that the first housing and the second housing can overlap one another in a direction of thickness of the first housing and the second housing; a communication section; an imaging section; a light emitting section that emits light for supplementing imaging by the imaging section; a radio antenna disposed in the first housing; a capacitor that is disposed in the second housing and supplies power to the light emitting section; and a charging section that is disposed in the second housing and charges the capacitor, wherein the charging section and the radio antenna section are positioned not to face one another in a direction of thickness of the first housing and the second housing when the first housing and the second housing overlap one another.

The invention also provides a portable terminal having an imaging function, having: a first housing; a second housing coupled with the first housing rotatably through a coupling section; a communication section; an imaging section; a light emitting section that emits light for supplementing imaging by the imaging section; a radio antenna located disposed in the second housing; a capacitor that is disposed in the second housing and supplies power to the light emitting section; and a charging section that is disposed in the second housing and charges the capacitor, wherein the radio antenna is positioned at one end of the second housing and the charging section is positioned at another end of the second housing, the one end and the another end which are opposed to one another in a direction of a surface of the second hosing.

Furthermore, the communication section has a high frequency circuit that processes a high frequency signal, and the light emitting section and the high frequency circuit are disposed in the second housing.

Furthermore, the communication section has a high frequency circuit that processes a high frequency signal, the light emitting section is disposed in the first housing, the high frequency circuit is disposed in the second housing, the light emitting section and the capacitor are connected through a first wiring that passes through the inside of the coupling section, the radio antenna and the high frequency circuit are connected through a second wiring that passes through the inside of the coupling section, and the first wiring and the second wiring pass through the inside of the coupling section to be away from each other in a direction of width of the coupling section.

Furthermore, a speaker is disposed in the first housing, and the speaker and the charging section are positioned not to face one another in a direction of thickness of the first housing and the second housing when the first housing and the second housing overlap one another.

Furthermore, a speaker which outputs a sound is disposed in the second housing, and the speaker is positioned at one end of the second housing and the charging section is positioned at another end of the second housing, the one end and the another end which are opposed to one another in a direction of a surface of the second housing.

The portable terminal further has a control section that controls the communication section and the charging section, wherein when the communication section receives an incoming call during charging by the charging section, the control section controls the charging section to stop the charging and controls to notify the incoming call.

Furthermore, when the control section determines that a communication by the communication section based on the incoming call is terminated, the control section controls the charging section to resume the charging.

According to the portable terminal, it is possible to reduce the effects from electrical noise generated in the charging section used for charging the capacitor of the light emitting section. Therefore, it is possible to prevent the communication function of the portable terminal from erroneously operating.

### BRIEF DESCRIPTION OF THE DRAWINGS

FIG. 1 is a perspective view of a cellular phone 2 having an imaging function according to a first embodiment of the present invention;

FIG. 2 is a block diagram showing a circuit configuration of the cellular phone 2 having an imaging function according to the first embodiment of the present invention;

FIG. 3 is a plan view of the cellular phone 2 having the imaging function shown in FIG. 1;

FIG. 4 is a flowchart showing an operation sequence of a control section 76 shown in FIG. 2;

FIG. 5 is a flowchart showing an operation sequence of the control section 76 of a cellular phone 4 having an imaging function according to a second embodiment of the present invention;

FIG. 6 is a perspective view of a cellular phone 6 having an imaging function according to a third embodiment of the present invention;

FIG. 7 is a plan view of the cellular phone 6 having an imaging function shown in FIG. 6;

FIG. 8 is a plan view of a cellular phone 8 having an imaging function according to a fourth embodiment of the present invention;

FIG. 9 is a plan view of a cellular phone 10 having an imaging function according to a fifth embodiment of the present invention;

FIG. 10 is a plan view of a cellular phone 12 having an imaging function according to a sixth embodiment of the present invention;

FIG. 11 is a plan view of a cellular phone 14 having an imaging function according to a seventh embodiment of the present invention;

FIG. 12 is a perspective view of a cellular phone 16 having an imaging function according to an eighth embodiment of the present invention;

FIG. 13 is a plan view of the cellular phone 16 having an imaging function shown in FIG. 12;

FIG. 14 is a plan view of a cellular phone 18 having an imaging function according to a ninth embodiment of the present invention;

FIG. 15 is a plan view of a cellular phone 20 having an imaging function according to a tenth embodiment of the present invention; and

FIG. 16 is a plan view of a cellular phone 22 having an imaging function according to an eleventh embodiment of the present invention.

### DETAILED DESCRIPTION OF THE PREFERRED EMBODIMENTS

Embodiments of a portable terminal having an imaging function according to the present invention will be described with reference to the attached drawings.

### First Embodiment

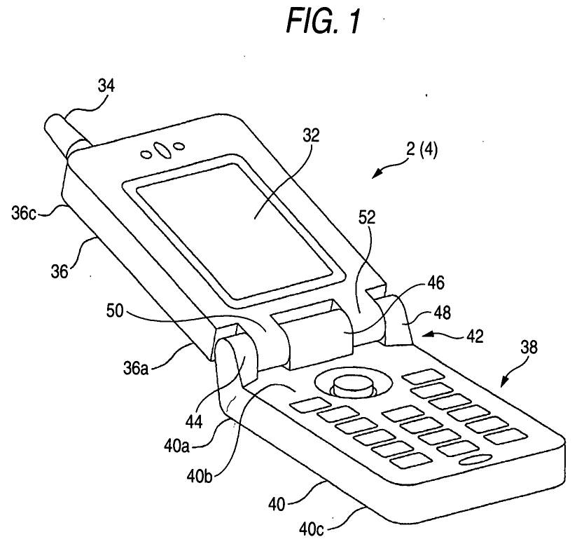

FIGS. 1 to 4 are diagrams illustrating a cellular phone 2 having an imaging function (corresponding to the portable terminal having the imaging function) of a first embodiment of the present invention.

As shown in FIG. 1, the cellular phone 2 having the imaging function according to the present embodiment has an upper housing 36 having a display section 32 such as a LCD (Liquid Crystal Display) and an extendable radio antenna 34, and a lower housing 40 having an operating section 38. And then, an end portion 36a in a lengthwise direction of the upper housing 36 and an end portion 40a in a lengthwise direction of the lower housing 40 are rotatably connected to each other by means of a connecting section 42 employing a hinge structure.

That is, in the end portion 40a of the lower housing 40, three convex portions 44, 46 and 48 are formed to be spaced apart at their respective predetermined intervals from each other in a widthwise direction of the lower housing 40. Further, in the end portion 36a of the upper housing 36, a projection 50 to be engaged between the convex portion 44 and the convex portion 46 of the end portion 40a in the lower housing 40, and a projection 52 to be engaged between the convex portion 46 and the convex portion 48 are formed.

And then, the end portion 40a of the lower housing 40 and the end portion 36a of the upper housing 36 are pinned together such that the adjacent convex portion 44 and the projection 50 may be rotated separately. Though not shown, a pin member to be used for the connection has a hollow shaft structure.

Further, the convex portion 46 and the projection 50, the convex portion 46 and the projection 52, and the convex portion 48 and the projection 50 are pinned on the same shaft line by means of a hollow shaft structure respectively.

Therefore, internal spaces of the lower housing 40 and the upper housing 36 are linked in a direction which the convex portions 44, 46 and 48 and the projections 50 and 52 lie adjacent to each other in the connecting section 42. Accordingly, an electrical wiring such as a flexible printed wiring board can pass through the lower housing 40 and the upper housing 36.

As shown in FIG. 1, by rotating the upper housing 36 by a predetermined angle, the cellular phone 2 having the imaging function can be switched over from an opened state in which the operating section 38 is exposed to be operated to a closed state in which the upper housing 36 and the lower housing 40 overlap each other in a thickness direction such that the display section 32 faces an operation surface 40b on which the operating section 38 of the lower housing 40 is disposed.

Further, an imaging section 60 described below is configured such that an imaging lens thereof is exposed on a rear surface opposite to the operation surface 40b of the lower housing 40, and thus it is not shown in FIG. 1. Further, a light emitting section 62 is configured such that light is emitted in the same direction as an imaging direction of the imaging section 60, and thus it is also not shown in FIG. 1.

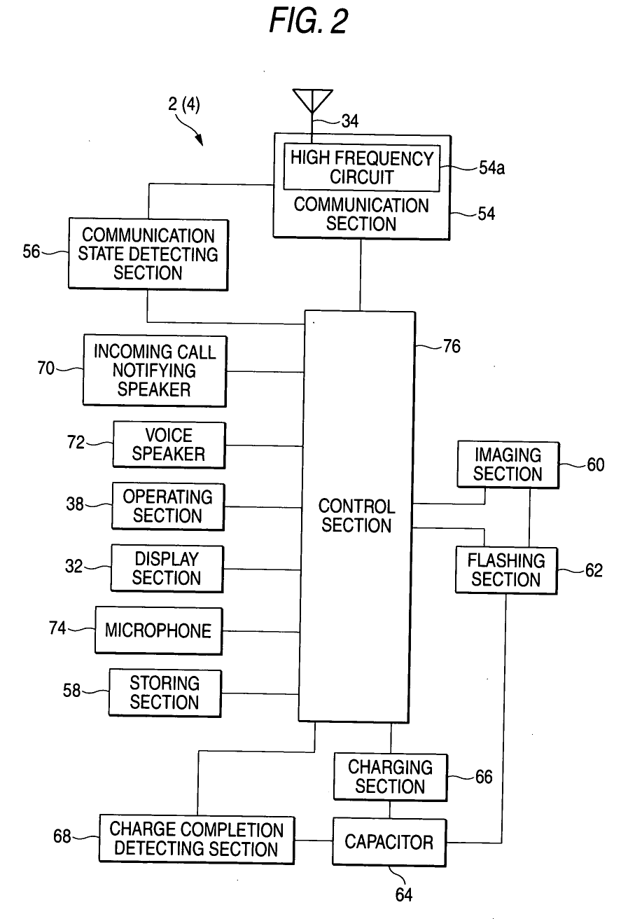

FIG. 2 is a block diagram showing a circuit configuration of the cellular phone 2 having the imaging function. The cellular phone 2 having the imaging function has the display section 32, the operating section 38, a communication section 54, a communication state detecting section 56, a storing section 58, the imaging section 60, the light emitting section 62, an electrolytic capacitor 64, a charging section 66, a charge completion detecting section 68, an incoming call notifying speaker 70, a voice speaker 72, a microphone 74 and a control section 76 which controls these elements.

Further, the communication section 54 has a high frequency circuit 54a processing a high frequency signal, and the radio antenna 34 is connected to the high frequency circuit 54a. When the communication section 54 is communicating, the communication state detecting section 56 detects the communication state and outputs a signal indicative of the communication state to the control section 76. Further, the charge completion detecting section 68 detects whether or not the charge to the electrolytic capacitor 64 by the charging section 66 is completed.

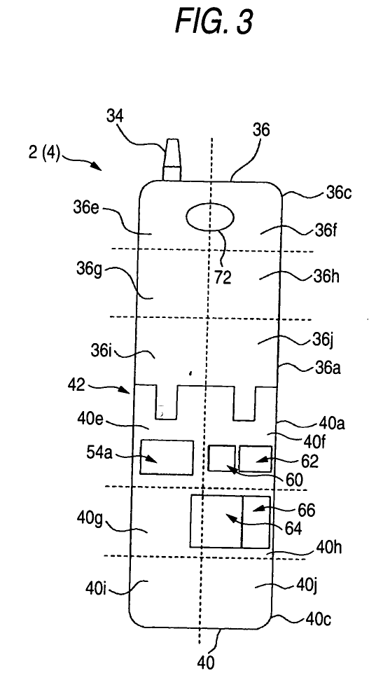

FIG. 3 shows positions of the radio antenna 34, and the high frequency circuit 54a, the imaging section 60, the light emitting section 62, the electrolytic capacitor 64, the charging section 66 and the voice speaker 72 disposed in the cellular phone 2 having the imaging function in a plan view when the cellular phone 2 having the imaging function is in the opened state.

Inside the upper housing 36 and the lower housing 40, other components or a printed board, other than the high frequency circuit 54a, the imaging section 60, the light emitting section 62, the electrolytic capacitor 64, the charging section 66 and the voice speaker 72, are disposed, but these elements are not shown in FIG. 3.

Note that the high frequency circuit 54a, the imaging section 60, the light emitting section 62, the electrolytic capacitor 64, the charging section 66 and the voice speaker 72 may be respectively disposed not to overlap other components than these elements in a thickness direction of the upper housing 36 or the lower housing 40.

In the following description, in order to specify positions at which the high frequency circuit 54a, the imaging section 60, the light emitting section 62, the electrolytic capacitor 64, the charging section 66 and the voice speaker 72 are disposed, the inside of each of the upper housing 36 and the lower housing 40 which is defined in a widthwise direction and a lengthwise direction of each of the upper housing 36 and the lower housing 40 is bisected in the widthwise direction and trisected in the lengthwise direction. The respective divisions are marked.

That is, in the upper housing 36, two divisions which are disposed in the widthwise direction at an end portion 36c opposite to the end portion 36a of the connecting section 42 side are marked with reference numerals 36e and 36f, and further, in an order from the division closest to the end portion 36c, divisions are marked with reference numerals 36g, 36h, 36i and 36j.

Further, in the lower housing 40, two divisions which are disposed in the widthwise direction at the end portion 40a of the connecting section 42 side are marked with reference numerals 40e and 40f, and further, in an order from the division closest to an end portion 40c opposite to the end portion 40a, divisions are marked with reference numerals 40i, 40j, 40g, and 40h.

The radio antenna 34 is disposed in the division 36e of the upper housing 36. Further, though not shown, when the radio antenna 34 is extended, a feeding terminal to be electrically connected to the radio antenna 34 is also disposed in the division 36e. The voice speaker 72 is disposed at an intermediate position of the division 36e and the division 36f.

Further, the high frequency circuit 54a is disposed in the division 40e of the lower housing 40, and the imaging section 60 and the light emitting section 62 are disposed in the division 40f. The electrolytic capacitor 64 and the charging section 66 are disposed in the division 40h.

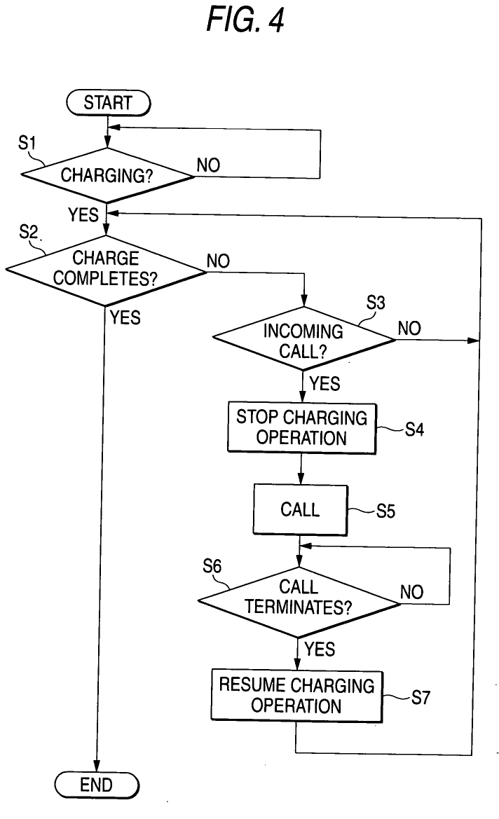

Further, in the case in which an incoming call is received when the charging section 66 is charging the electrolytic capacitor 64, the control section 76 in FIG. 2 performs the processing operations as shown in a flowchart of FIG. 4.

If an operation for using the light emitting section 62 is performed by a user, the control section 76 allows the charging section 66 to charge the electrolytic capacitor 64. When the charge is completed, based on a detection signal from the charge completion detecting section 68, the control section 76 stops the charge by the charging section 66 (“YES” in step S1 and “YES” in step S2 of FIG. 4).

In the case in which a call request is received when the charge by the charging section 66 is being performed (“YES” in step S1, “NO” in step S2 and “YES” in step S3), even when the charge to the electrolytic capacitor 64 is not completed, the charge by the charging section 66 is stopped (step S4). Further, a notifying sound for informing the user of the incoming call is outputted from the incoming call notifying speaker 70. During the call in step S5, the charging section 66 does not perform the charging operation.

And then, if it is determines that the call is ended (“YES” in step S6 of FIG. 4), based on the detection signal from the communication state detecting section 56 (see FIG. 2), the control section 76 allows the charging section 66 to resume the charge (step S7), and then the process returns to the flow before step S2.

According to such a cellular phone 2 having the imaging function, as shown in FIG. 3, when it is switched over to the closed state in which the upper housing 36 and the lower housing 40 are folded to overlap each other, the radio antenna 34 and the charging section 66 do not face each other in the thickness directions of the upper housing 36 and the lower housing 40. Thus, the effects on the radio antenna 34 from electrical noise generated by the charging section 66 can be reduced. Therefore, it is possible to prevent the communication function of the cellular phone 2 from erroneously operating.

Further, since the light emitting section 62 is disposed in the lower housing 40, an electrical wiring between the electrolytic capacitor 64 and the light emitting section 62 need not pass through the connecting section 42. Thus, the electrical wiring does not come close to an electrical wiring between the high frequency circuit 54a and the radio antenna 34. Therefore, the effects on the high frequency circuit 54a and the radio antenna 34 from noise, which is generated at the time of feeding from the electrolytic capacitor 64 to the light emitting section 62, can be reduced. Thus, it is possible to prevent the communication function of the cellular phone 2 from erroneously operating (for example, an incoming call signal can be accurately detected).

Further, when the cellular phone 2 having the imaging function is switched over to the closed state, the voice speaker 72 and the charging section 66 do not face each other in the thickness directions of the upper housing 36 and the lower housing 40. Thus, the effects on the voice speaker 72 from electrical noise generated by the charging section 66 can be reduced. Therefore, it is possible to prevent the noise from interfering in a voice to be outputted.

Further, generally, a ceramic capacitor or the like to be used for the charging section 66 generates a minute abnormal sound due to piezoelectric effect. Thus, if the charging section 66 is disposed at a position opposing the voice speaker 72, since the user brings his ear close to the voice speaker 72 at the time of calling, the user is likely to hear the abnormal sound. To the contrary, in the present embodiment, since the voice speaker 72 and the charging section 66 do not face each other in the thickness directions of the upper housing 36 and the lower housing 40, it is possible to prevent the user from hearing the abnormal sound.

Further, as shown in the flowchart of FIG. 4, in the case in which an incoming call is received during the charge to the electrolytic capacitor 64 by the charging section 66, the control section 76 stops the charging operation by the charging section 66. Thus, it is possible to prevent the communication function of the cellular phone 2 from erroneously operating.

### Second Embodiment

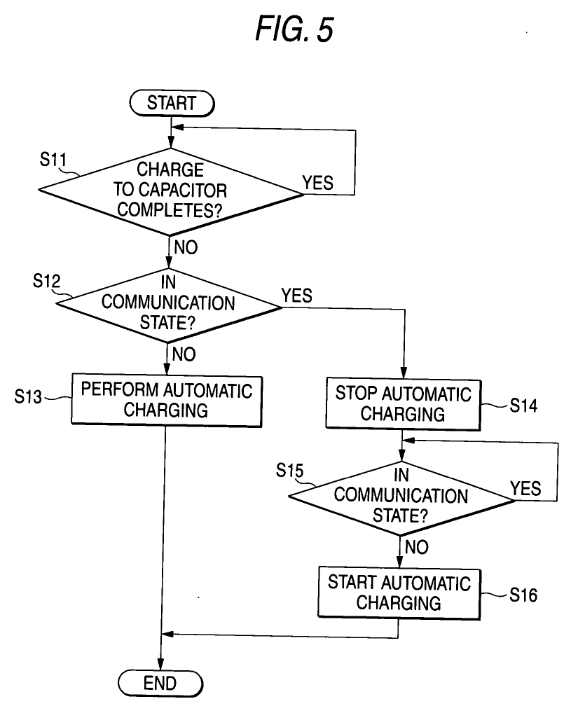

Next, a cellular phone 4 having an imaging function according to a second embodiment of the present invention will be described with reference to FIG. 5. The cellular phone 4 having the imaging function according to the present embodiment has the same configuration as that of the cellular phone 2 having the imaging function according to the first embodiment, except that the control section 76 performs different processing operations.

If the use of the light emitting section 62 at the time of capturing an image is selected by an operation of the user, the control section 76 of the cellular phone 4 having the imaging function allows the charging section 66 to automatically start the charge to the electrolytic capacitor 64. And then, the control section 76 performs processing operations as shown in FIG. 5 just before the charging operation is started.

Just before the charge of the electrolytic capacitor 64 by the charging section 66 is started, based on the detection signal from the charge completion detecting section 68 (see FIG. 2), the control section 76 determines whether or not the charge of the electrolytic capacitor 64 is completed to have a constant voltage required for using the light emitting section 62 (step S11 of FIG. 5).

And then, if it is determined that the capacitor is not charged up to the constant voltage and the charge is required (“NO” in step S11), the control section 76 determines whether or not the communication section 54 is communicating (step S12). The determination in step S12 is performed based on the signal from the communication state detecting section 56.

If the communication section 54 is not communicating (“NO” in step S12), the control section 76 allows the charging section 66 to start the charging operation to the electrolytic capacitor 64 (step S13). If the communication section 54 is communicating (“YES” in step S12), even when the charge to the electrolytic capacitor 64 is required, the control section 76 stops starting the charging operation (step S14).

And then, based on the signal from the communication state detecting section 56, the control section 76 controls the charging section 66 not to start the charging operation during consecutive communication state (“YES” in step S15). If communication is ended, the control section 76 allows the charging section 66 to start the charge (“NO” in step S15 and step S16).

According to such a cellular phone 4 having the imaging function of the present embodiment, similarly to the first embodiment shown in FIG. 3, when it is switched over to the closed state in which the upper housing 36 and the lower housing 40 are folded to overlap each other, the radio antenna 34 and the charging section 66 do not face each other in the thickness directions of the upper housing 36 and the lower housing 40. Thus, the effects on the radio antenna 34 from electrical noise generated by the charging section 66 can be reduced. Therefore, it is possible to prevent the communication function of the cellular phone 4 from erroneously operating.

Further, similarly to the first embodiment, since the light emitting section 62 is disposed in the lower housing 40, it is not necessarily configured such that the electrical wiring between the electrolytic capacitor 64 and the light emitting section 62 passes through the connecting section 42. Thus, at the time of allowing the light emitting section 62 to emit, a high voltage current of hundreds voltages is supplied from the electrolytic capacitor 64, but the electrical wiring does not come close to the electrical wiring between the high frequency circuit 54a and the radio antenna 34. Therefore, the effects on the high frequency circuit 54a and the radio antenna 34 from noise, which is generated at the time of feeding from the electrolytic capacitor 64 to the light emitting section 62, can be reduced. As a result, it is possible to prevent the communication function of the cellular phone 4 from erroneously operating.

Further, similarly to the first embodiment, when the cellular phone 4 having the imaging function is switched over to the closed state, the voice speaker 72 and the charging section 66 do not face each other in the thickness directions of the upper housing 36 and the lower housing 40. Thus, the effects on the voice speaker 72 from electrical noise generated by the charging section 66 can be reduced. Therefore, it is possible to prevent the noise from interfering in a voice to be outputted.

Further, generally, a ceramic capacitor or the like to be used for the charging section 66 generates a minute abnormal sound due to piezoelectric effect. Thus, if the charging section 66 is disposed at a position opposing the voice speaker 72, since the user brings his ear close to the voice speaker 72 at the time of calling, the user is likely to hear the abnormal sound. To the contrary, in the present embodiment, since the voice speaker 72 and the charging section 66 do not face each other in the thickness directions of the upper housing 36 and the lower housing 40, it is possible to prevent the user from hearing the foreign sound.

Further, as shown in the flowchart of FIG. 5, just before the charge to the electrolytic capacitor 64 by the charging section 66 is automatically started, the control section 76 determines whether or not the communication section 54 is in the communication state. And then, if it is determined that the communication section 54 is in the communication state, the control section 76 stops the charging operation. Thus, it is possible to prevent the communication function of the cellular phone 4 from erroneously operating.

### Third Embodiment

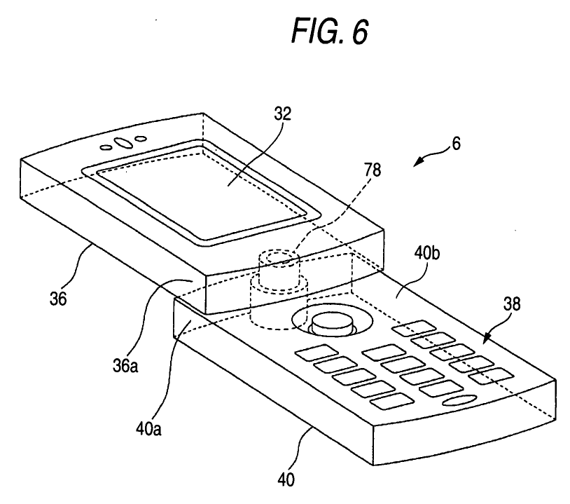

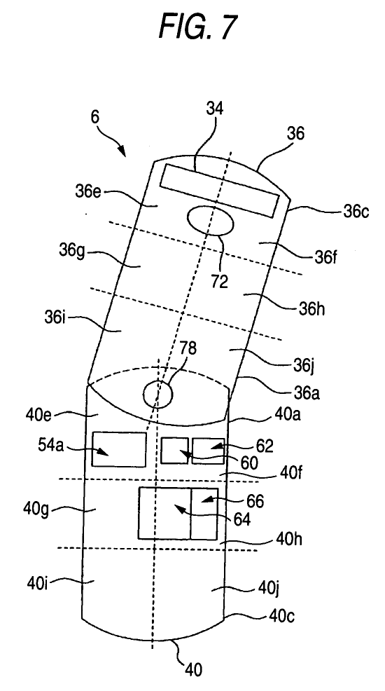

Next, a cellular phone 6 having an imaging function according to a third embodiment of the present invention will be described with reference to FIGS. 6 and 7.

As shown in FIG. 6, the cellular phone 6 having the imaging function according to the present embodiment has the upper-housing 36 having the display section 32, and the lower housing 40 having the operating section 38. The end portions 36a and 40a of the upper housing 36 and the lower housing 40 are connected by means of a connecting shaft 78 (the connecting section) having a shaft line substantially orthogonal to the operation surface 40b on which the operating section 38 of the lower housing 40 is disposed. Further, the upper housing 36 and the lower housing 40 are configured to freely rotate (freely open and close) in a parallel direction to each other. The connecting shaft 78 has a hollow shape, and an electrical wiring between the upper housing 36 and the lower housing 40 is configured to pass through the connecting shaft 78.

In the cellular phone 6 having the imaging function, it is configured such that a display surface of the display section 32 may be exposed to the outside in an opened state in which a user can operate the operating section 38, like a state shown in FIG. 6, and in a closed state in which the upper housing 36 rotates by substantially 180° to the lower housing 40 from the opened state such that the upper housing 36 and the lower housing 40 overlap each other in the thickness direction.

As shown in FIG. 7, the radio antenna 34 and the voice speaker 72 are disposed to extend over the division 36e and the division 36f of the upper housing 36. Further, the high frequency circuit 54a is disposed in the division 40e of the lower housing 40, and the imaging section 60 and the light emitting section 62 are disposed in the division 40f. The electrolytic capacitor 64 and the charging section 66 are disposed in the division 40h.

According to such a cellular phone 6 having the imaging function of the present embodiment, similarly to the above-mentioned first and second embodiments, when the upper housing 36 and the lower housing 40 rotate to each other such that the cellular phone 6 having the imaging function is switched over to the closed state, the radio antenna 34 and the charging section 66 do not face each other in the thickness directions of the upper housing 36 and the lower housing 40. Thus, the effects on the radio antenna 34 from electrical noise generated by the charging section 66 can be reduced. Therefore, it is possible to prevent the communication function of the cellular phone 6 from erroneously operating.

Further, similarly to the above-mentioned first and second embodiments, since the light emitting section 62 is disposed in the lower housing 40, it is not necessarily configured that the electrical wiring between the electrolytic capacitor 64 and the light emitting section 62 passes through the connecting shaft 78. Thus, the electrical wiring does not come close to the electrical wiring between the high frequency circuit 54a and the radio antenna 34. Therefore, the effects on the high frequency circuit 54a and the radio antenna 34 from noise, which is generated at the time of feeding from the electrolytic capacitor 64 to the light emitting section 62, can be reduced. As a result, it is possible to prevent the communication function of the cellular phone 6 from erroneously operating.

Further, similarly to the above-mentioned first and second embodiments, when the cellular phone 6 having the imaging function is switched over to the closed state, the voice speaker 72 and the charging section 66 do not face each other in the thickness directions of the upper housing 36 and the lower housing 40. Thus, the effects on the voice speaker 72 from electrical noise generated by the charging section 66 can be reduced. Therefore, it is possible to prevent the noise from interfering in a voice to be outputted.

Further, generally, a ceramic capacitor or the like to be used for the charging section 66 generates a minute foreign sound due to piezoelectric effect. Thus, if the charging section 66 is disposed at a position opposing the voice speaker 72, since the user brings his ear close to the voice speaker 72 at the time of calling, the user is likely to hear the foreign sound. To the contrary, in the present embodiment, since the voice speaker 72 and the charging section 66 do not face each other in the thickness directions of the upper housing 36 and the lower housing 40, it is possible to prevent the user from hearing the foreign sound.

### Fourth Embodiment

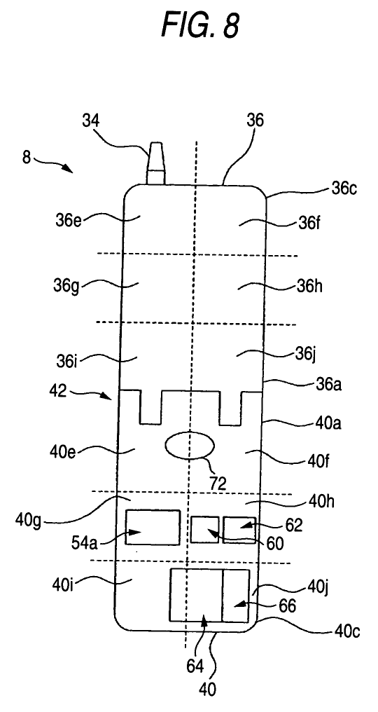

Next, a cellular phone 8 having an imaging function according to a fourth embodiment of the present invention will be described with reference to FIG. 8.

The cellular phone 8 having the imaging function according to the present embodiment is configured, like the above-mentioned first embodiment, such that the upper housing 36 and the lower housing 40 are folded to overlap each other. And then, the radio antenna 34 is disposed in the division 36e of the upper housing 36. Further, the voice speaker 72 is disposed at an intermediate position of the division 40e and the division 40f of the lower housing 40. The high frequency circuit 54a is disposed in the division 40g, and the imaging section 60 and the light emitting section 62 are disposed in the division 40h. The electrolytic capacitor 64 and the charging section 66 are disposed in the division 40j.

According to such a cellular phone 8 having the imaging function of the present embodiment, similarly to the previously-mentioned first and second embodiments, when it is switched over to the closed state in which the upper housing 36 and the lower housing 40 are folded to overlap each other, the radio antenna 34 and the charging section 66 do not face each other in the thickness directions of the upper housing 36 and the lower housing 40. Thus, the effects on the radio antenna 34 from electrical noise generated by the charging section 66 can be reduced. Therefore, it is possible to prevent the communication function of the cellular phone 8 from erroneously operating.

Further, similarly to the above-mentioned first and second embodiments, since the light emitting section 62 is disposed in the lower housing 40, it is not necessarily configured such that the electrical wiring between the electrolytic capacitor 64 and the light emitting section 62 passes through the connecting section 42. Thus, the electrical wiring does not come close to the electrical wiring between the high frequency circuit 54a and the radio antenna 34. Therefore, the effects on the high frequency circuit 54a and the radio antenna 34 from noise, which is generated at the time of feeding from the electrolytic capacitor 64 to the light emitting section 62, can be reduced. As a result, it is possible to prevent the communication function of the cellular phone 8 from erroneously operating.

Further, since the voice speaker 72 and the charging section 66 are respectively disposed at the different end portions 40a and 40c of the lower housing 40, the effects on the voice speaker 72 from electrical noise generated by the charging section 66 can be reduced. Thus, it is possible to prevent the noise from interfering in a voice to be outputted.

### Fifth Embodiment

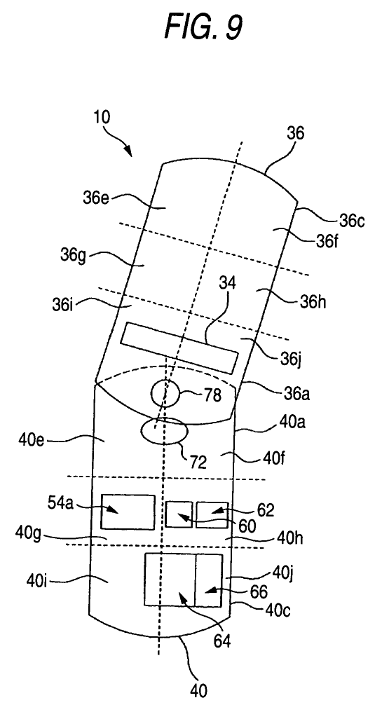

Next, a cellular phone 10 having an imaging function according to a fifth embodiment of the present invention will be described with reference to FIG. 9.

The cellular phone 10 having the imaging function according to the present embodiment is configured, like the above-mentioned third embodiment, such that the upper housing 36 and the lower housing 40 rotate in a parallel direction to each other. And then, the radio antenna 34 is disposed to extend over the division 36i and the division 36j of the upper housing 36. Further, the voice speaker 72 is disposed at an intermediate position of the division 40e and the division 40f of the lower housing 40. The high frequency circuit 54a is disposed in the division 40g, and the imaging section 60 and the light emitting section 62 are disposed in the division 40h. The electrolytic capacitor 64 and the charging section 66 are disposed in the division 40j.

According to such a cellular phone 10 having the imaging function of the present embodiment, similarly to the above-mentioned third embodiment, when it is switched over to the closed state in which the upper housing 36 and the lower housing 40 are folded to overlap each other, the radio antenna 34 and the charging section 66 do not face each other in the thickness directions of the upper housing 36 and the lower housing 40. Thus, the effects on the radio antenna 34 from electrical noise generated by the charging section 66 can be reduced. Thus, it is possible to prevent the communication function of the cellular phone 10 from erroneously operating.

Further, similarly to the above-mentioned third embodiment, since the light emitting section 62 is disposed in the lower housing 40, the electrical wiring between the electrolytic capacitor 64 and the light emitting section 62 need not pass through the connecting shaft 78. Thus, the electrical wiring does not come close to the electrical wiring between the high frequency circuit 54a and the radio antenna 34. Therefore, the effects on the high frequency circuit 54a and the radio antenna 34 from noise, which is generated at the time of feeding from the electrolytic capacitor 64 to the light emitting section 62, can be reduced. As a result, it is possible to prevent the communication function of the cellular phone 10 from erroneously operating.

Further, like the above-mentioned fourth embodiment, since the voice speaker 72 and the charging section 66 are respectively disposed at the different end portions 40a and 40c of the lower housing 40, the effects on the voice speaker 72 from electrical noise generated by the charging section 66 can be reduced. Thus, it is possible to prevent the noise from interfering in a voice to be outputted.

### Sixth Embodiment

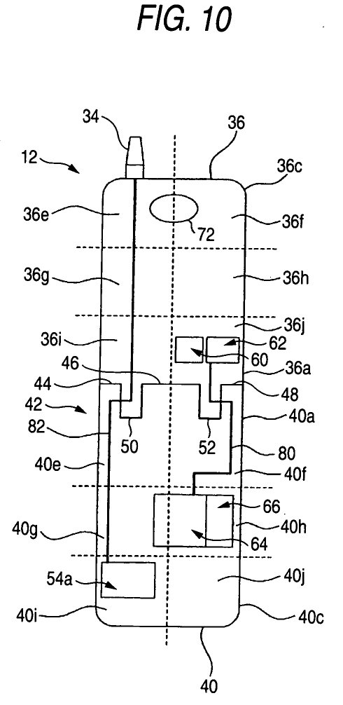

Next, a cellular phone 12 having an imaging function according to a sixth embodiment of the present invention will be described with reference to FIG. 10.

The cellular phone 12 having the imaging function according to the present embodiment is configured, like the previously-mentioned first embodiment and so on, such that the upper housing 36 and the lower housing 40 are folded to overlap each other. And then, the radio antenna 34 is disposed in the division 36e of the upper housing 36, and the voice speaker 72 is disposed at an intermediate position of the division 36e and the division 36f. The imaging section 60 and the light emitting section 62 are disposed in the division 36j. Further, the high frequency circuit 54a is disposed in the division 40i of the lower housing 40, and the electrolytic capacitor 64 and the charging section 66 are disposed in the division 40h.

And then, a first wiring 80 for electrically connecting the light emitting section 62 and the electrolytic capacitor 64 passes through the convex portion 48 and the projection 50 in the connecting section 42. Further, a second wiring 82 for electrically connecting the radio antenna 34 and the high frequency circuit 54a passes through the convex portion 44 and the projection 50 in the connecting section 42. In such a manner, the first wiring 80 and the second wiring 82 pass through the connecting section 42 while being spaced from each other.

According to such a cellular phone 12 having the imaging function of the present embodiment, similarly to the above-mentioned first embodiment and so on, when it is switched over to the closed state in which the upper housing 36 and the lower housing 40 are folded to overlap each other, the radio antenna 34 and the charging section 66 do not face each other in the thickness directions of the upper housing 36 and the lower housing 40. Thus, the effects on the radio antenna 34 from electrical noise generated by the charging section 66 can be reduced. Therefore, it is possible to prevent the communication function of the cellular phone 12 from erroneously operating.

Further, since the first wiring 80 and the second wiring 82 pass through the connecting section 42 while being spaced from each other, the effects on the high frequency circuit 54a and the radio antenna 34 from noise, which is generated at the time of feeding from the electrolytic capacitor 64 to the light emitting section 62, can be reduced. Thus, it is possible to prevent the communication function of the cellular phone 12 from erroneously operating.

Further, similarly to the above-mentioned first embodiment, when the cellular phone 12 having the imaging function is switched over to the closed state, the voice speaker 72 and the charging section 66 do not face each other in the thickness directions of the upper housing 36 and the lower housing 40. Thus, the effects on the voice speaker 72 from electrical noise generated by the charging section 66 can be reduced. Therefore, it is possible to prevent the noise from interfering in a voice to be outputted.

Further, generally, a ceramic capacitor or the like to be used for the charging section 66 generates a minute foreign sound due to piezoelectric effect. Thus, if the charging section 66 is disposed at a position opposing the voice speaker 72, since the user brings his ear close to the voice speaker 72 at the time of calling, the user is likely to hear the foreign sound. To the contrary, in the present embodiment, since the voice speaker 72 and the charging section 66 do not face each other in the thickness directions of the upper housing 36 and the lower housing 40, it is possible to prevent the user from hearing the foreign sound.

### Seventh Embodiment

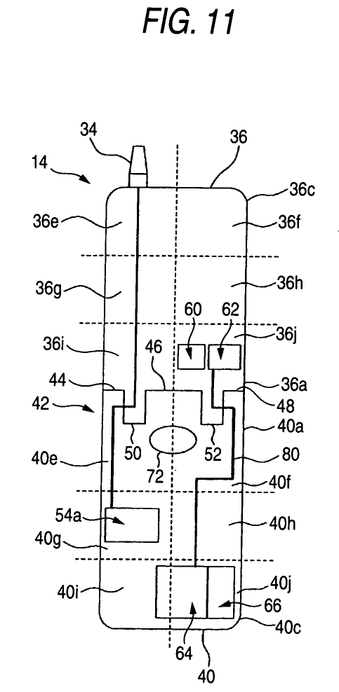

Next, a cellular phone 14 having an imaging function according to a seventh embodiment of the present invention will be described with reference to FIG. 11.

In the cellular phone 14 having the imaging function according to the present embodiment, the radio antenna 34 is disposed in the division 36e of the upper housing 36, and the imaging section 60 and the light emitting section 62 are arranged in the division 36j. Further, the voice speaker 72 is disposed in an intermediate position of the division 40e and the division 40f of the lower housing 40. The high frequency circuit 54a is disposed in the division 40g, and the electrolytic capacitor 64 and the charging section 66 are disposed in the division 40j.

According to such a cellular phone 14 having the imaging function of the present embodiment, similarly to the above-mentioned first embodiment, when it is switched over to the closed state in which the upper housing 36 and the lower housing 40 are folded to overlap each other, the radio antenna 34 and the charging section 66 do not face each other in the thickness directions of the upper housing 36 and the lower housing 40. Thus, the effects on the radio antenna 34 from electrical noise generated by the charging section 66 can be reduced. Therefore, it is possible to prevent the communication function of the cellular phone 14 from erroneously operating.

Further, since the first wiring 80 and the second wiring 82 pass through the connecting section 42 while being spaced from each other, the effects on the high frequency circuit 54a and the radio antenna 34 from noise, which is generated at the time of feeding from the electrolytic capacitor 64 to the light emitting section 62, can be reduced. Thus, it is possible to prevent the communication function of the cellular phone 14 from erroneously operating.

Further, since the voice speaker 72 and the charging section 66 are respectively disposed at the different end portions 40a and 40c of the lower housing 40, the effects on the voice speaker 72 from electrical noise generated by the charging section 66 can be reduced. Thus, it is possible to prevent the noise from interfering in a voice to be outputted.

### Eighth Embodiment

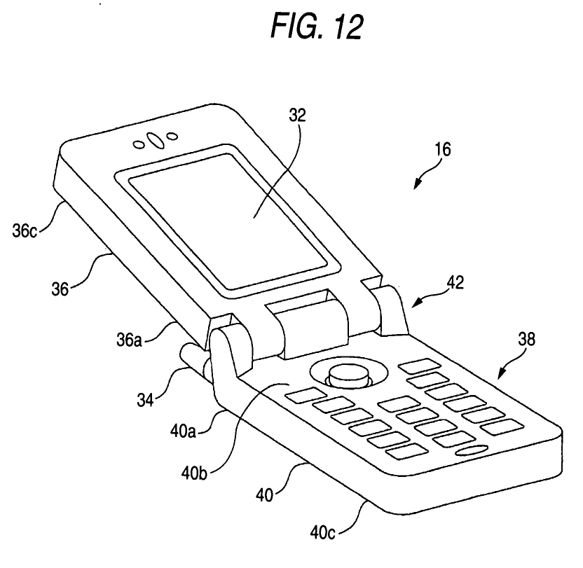

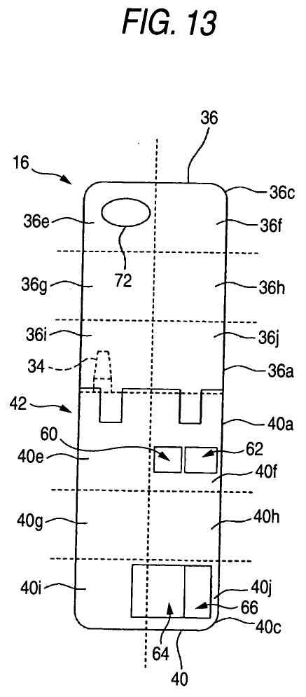

Next, a cellular phone 16 having an imaging function according to an eighth embodiment of the present invention will be described with reference to FIGS. 12 and 13.

As shown in FIG. 12, the cellular phone 16 having the imaging function according to the present embodiment is configured, like the above-mentioned first embodiment, such that the upper housing 36 and the lower housing 40 are folded to overlap each other. However, the present embodiment is different from the first embodiment or the like in that the radio antenna 34 is provided in the lower housing 40.

As shown in FIG. 13, in the cellular phone 16 having the imaging function, the voice speaker 72 is disposed in the division 36e of the upper housing 36. Further, the radio antenna is disposed in the division 40e of the lower housing 40, and the imaging section 60 and the light emitting section 62 are disposed in the division 40f. Further, the electrolytic capacitor 64 and the charging section 66 are disposed in the division 40j.

According to such a cellular phone 16 having the imaging function of the present embodiment, the radio antenna 34 and the charging section 66 are respectively disposed at the different end portions 40a and 40c of the lower housing 40. Thus, the effects on the radio antenna 34 from electrical noise generated by the charging section 66 can be reduced. Therefore, it is possible to prevent the communication function of the cellular phone 16 from erroneously operating.

Further, similarly to the above-mentioned first embodiment, when the cellular phone 16 having the imaging function is switched over to the closed state, the voice speaker 72 and the charging section 66 do not face each other in the thickness directions of the upper housing 36 and the lower housing 40. Thus, the effects on the voice speaker 72 from electrical noise generated by the charging section 66 can be reduced. Therefore, it is possible to prevent the noise from interfering in a voice to be outputted.

Further, generally, a ceramic capacitor or the like to be used for the charging section 66 generates a minute foreign sound due to piezoelectric effect. Thus, if the charging section 66 is disposed at a position opposing the voice speaker 72, since the user brings his ear close to the voice speaker 72 at the time of calling, the user is likely to hear the foreign sound. To the contrary, in the present embodiment, since the voice speaker 72 and the charging section 66 do not face each other in the thickness directions of the upper housing 36 and the lower housing 40, it is possible to prevent the user from hearing the foreign sound.

### Ninth Embodiment

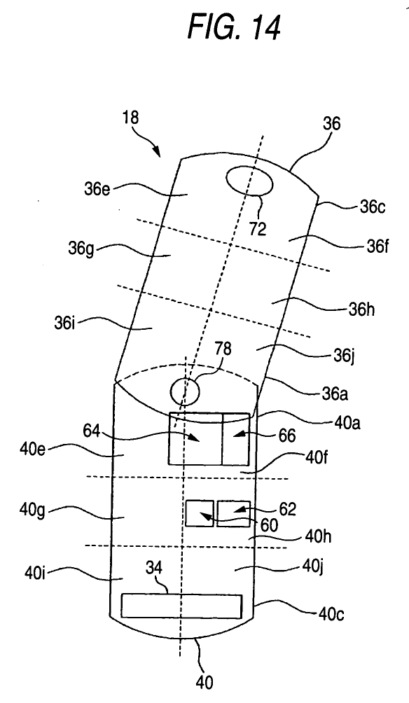

Next, a cellular phone 18 having an imaging function according to a ninth embodiment of the present invention will be described with reference to FIG. 14.

The cellular phone 18 having the imaging function according to the present embodiment is configured, like the above-mentioned third embodiment, such that the upper housing 36 and the lower housing 40 rotate in a parallel direction to each other. And then, the voice speaker 72 is disposed at an intermediate position of the division 36e and the division 36f of the upper housing 36. Further, the electrolytic capacitor 64 and the charging section 66 are disposed in the division 40f of the lower housing 40. The imaging section 60 and the light emitting section 62 are disposed in the division 40h, and the radio antenna 34 is disposed to extend over the division 40i and the division 40j.

According to such a cellular phone 18 having the imaging function of the present embodiment, similarly to the above-mentioned eighth embodiment, the radio antenna 34 and the charging section 66 are respectively disposed at the different end portions 40a and 40c of the lower housing 40. Thus, the effects on the radio antenna 34 from electrical noise generated by the charging section 66 can be reduced. Therefore, it is possible to prevent the communication function of the cellular phone 18 from erroneously operating.

Further, similarly to the above-mentioned first embodiment, when the cellular phone 18 having the imaging function is switched over to the closed state, the voice speaker 72 and the charging section 66 do not face each other in the thickness directions of the upper housing 36 and the lower housing 40. Thus, the effects on the voice speaker 72 from electrical noise generated by the charging section 66 can be reduced. Therefore, it is possible to prevent the noise from interfering in a voice to be outputted.

Further, generally, a ceramic capacitor or the like to be used for the charging section 66 generates a minute foreign sound due to piezoelectric effect. Thus, if the charging section 66 is disposed at a position opposing the voice speaker 72, since the user brings his ear close to the voice speaker 72 at the time of calling, the user is likely to hear the foreign sound. To the contrary, in the present embodiment, since the voice speaker 72 and the charging section 66 do not face each other in the thickness directions of the upper housing 36 and the lower housing 40, it is possible to prevent the user from hearing the foreign sound.

### Tenth Embodiment

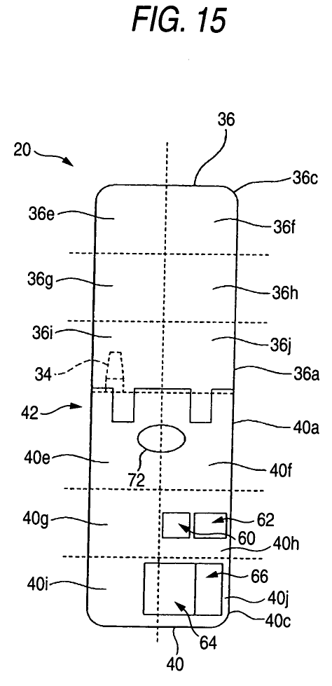

Next, a cellular phone 20 having an imaging function according to a tenth embodiment of the present invention will be described with reference to FIG. 15.

The cellular phone 20 having the imaging function according to the present embodiment is configured, like the above-mentioned eighth embodiment, such that the upper housing 36 and the lower housing 40 are folded to overlap each other, and the radio antenna 34 is provided in the lower housing 40. And then, the radio antenna 34 is disposed in the division 40e of the lower housing 40, and the voice speaker 72 is disposed at an intermediate position of the division 40e and the division 40f. Further, the imaging section 60 and the light emitting section 62 are disposed in the division 40h, and the electrolytic capacitor 64 and the charging section 66 are disposed in the division 40j.

According to such a cellular phone 20 having the imaging function of the present embodiment, the radio antenna 34 and the charging section 66 are respectively disposed at the different end portions 40a and 40c of the lower housing 40. Thus, the effects on the radio antenna 34 from electrical noise generated by the charging section 66 can be reduced. Therefore, it is possible to prevent the communication function of the cellular phone 20 from erroneously operating.

Further, like the radio antenna 34, the voice speaker 72 is disposed at the end portion 40a opposite to the charging section 66, and thus the effects on the voice speaker 72 from electrical noise generated by the charging section 66 can be reduced. Therefore, it is possible to prevent the noise from interfering in a voice to be outputted.

### Eleventh Embodiment

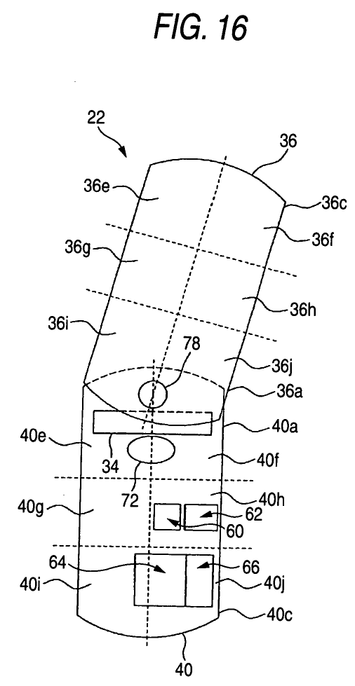

Next, a cellular phone 22 having an imaging function according to an eleventh embodiment of the present invention will be described with reference to FIG. 16.

The cellular phone 22 having the imaging function according to the present embodiment is configured, like the above-mentioned third embodiment, such that the upper housing 36 and the lower housing 40 rotate in a parallel direction to each other. And then, the radio antenna 34 is disposed to extend over the division 40e and the division 40f of the lower housing 40, and the voice speaker 72 is disposed at an intermediate position of the division 40e and the division 40f. Further, the imaging section 60 and the light emitting section 62 are disposed in the division 40h, and the electrolytic capacitor 64 and the charging section 66 are disposed in the division 40j.

According to such a cellular phone 22 having the imaging function of the present embodiment, the radio antenna 34 and the charging section 66 are respectively disposed at the different end portions 40a and 40c of the lower housing 40. Thus, the effects on the radio antenna 34 from electrical noise generated by the charging section 66 can be reduced. Therefore, it is possible to prevent the communication function of the cellular phone 22 from erroneously operating.

Further, like the radio antenna 34, the voice speaker 72 is disposed at the end portion 40a opposite to the charging section 66, and thus the effects on the voice speaker 72 from electrical noise generated by the charging section 66 can be reduced. Therefore, it is possible to prevent the noise from interfering in a voice to be outputted.

Moreover, the control section 76 of the cellular phone 2 having the imaging function according to the first embodiment is configured, in the processing operations of the flowchart shown in FIG. 4, to stop the charging operation by the charging section 66 in step S4, and then to resume the charging operation in step S7. However, the processing operations from step S5 to step S7 may not be performed by the control section 76.

Further, the control section 76 of the cellular phone 4 having the imaging function according to the second embodiment is configured, in the processing operations of the flowchart shown in FIG. 5, to stop the start of the charging operation by the charging section 66 in step S4, and then to start the charging operation in step S6. However, the processing operations of step S5 and step S6 may not be performed by the control section 76.

Further, the control section 76 of each of the cellular phones 6, 8, 10, 12, 14, 16, 20 and 22 having the imaging function according to the third to eleventh embodiments may be configured to perform processing operations based on the flowchart of FIG. 4 or 5, like the control section 76 of the first and second embodiment.

Further, in the first to eleventh embodiments, the upper housing 36 and the lower housing 40 are respectively divided into the six divisions, in which the radio antenna 34, the high frequency circuit 54a, the imaging section 60, the light emitting section 62, the electrolytic capacitor 64, the charging section 66 and the voice speaker 72 are disposed. However, the number of the divisions is not limited to six. For example, based on the same technical concept, the upper housing 36 and the lower housing 40 may be respectively divided such that the respective divisions are large enough for the respective components to be disposed in.

Further, the first to eleventh embodiments are described in accordance with the examples in which the radio antenna 34, and the high frequency circuit 54a, the imaging section 60, the light emitting section 62, the electrolytic capacitor 64, the charging section 66 and the voice speaker 72 to be disposed in the cellular phone 2 having the imaging function are disposed in the respective insides of the upper housing 36 and the lower housing 40. Alternatively, in the descriptions, the terms of “the upper housing 36” and “the lower housing 40” may be interchanged.

That is, assuming that, among the upper housing 36 and the lower housing 40, one housing in which the charging section 66 is disposed is generally referred to as a first housing, and another housing is referred to as a second housing, “the upper housing 36” and “the lower housing 40” may be referred to as “the second housing” and “the first housing” respectively like the examples described in the first to the eleventh embodiments. Reversely, “the upper housing 36” and “the lower housing 40” may be referred to as “the first housing” and “the second housing”.

Further, in the first to eleventh embodiments, the present invention is applied to the cellular phones 2 to 22 having the imaging function. However, it is needless to say that the present invention may be applied to other portable terminals having an imaging function which has the light emitting section.

1. A portable terminal having an imaging function, comprising:
a first housing;
a second housing coupled with the first housing rotatably through a coupling section so that the first housing and the second housing can overlap one another in a direction of thickness of the first housing and the second housing;
a communication section;
an imaging section;
a light emitting section that emits light for supplementing imaging by the imaging section;
a radio antenna disposed in the first housing;
a capacitor that is disposed in the second housing and supplies power to the light emitting section; and
a charging section that is disposed in the second housing and charges the capacitor,
wherein the charging section and the radio antenna section are positioned not to face one another in a direction of thickness of the first housing and the second housing when the first housing and the second housing overlap one another.

2. A portable terminal having an imaging function, comprising:
a first housing;
a second housing coupled with the first housing rotatably through a coupling section;
a communication section;
an imaging section;
a light emitting section that emits light for supplementing imaging by the imaging section;
a radio antenna located disposed in the second housing;
a capacitor that is disposed in the second housing and supplies power to the light emitting section; and
a charging section that is disposed in the second housing and charges the capacitor,
wherein the radio antenna is positioned at one end of the second housing and the charging section is positioned at another end of the second housing, the one end and the another end which are opposed to one another in a direction of a surface of the second hosing.

3. The portable terminal according to claim 1,
wherein the communication section has a high frequency circuit that processes a high frequency signal, and
the light emitting section and the high frequency circuit are disposed in the second housing.

4. The portable terminal according to claim 2,
wherein the communication section has a high frequency circuit that processes a high frequency signal, and
the light emitting section and the high frequency circuit are disposed in the second housing.

5. The portable terminal according to claim 1,
wherein the communication section has a high frequency circuit that processes a high frequency signal,
the light emitting section is disposed in the first housing,
the high frequency circuit is disposed in the second housing,
the light emitting section and the capacitor are connected through a first wiring that passes through the inside of the coupling section,
the radio antenna and the high frequency circuit are connected through a second wiring that passes through the inside of the coupling section, and
the first wiring and the second wiring pass through the inside of the coupling section to be away from each other in a direction of width of the coupling section.

6. The portable terminal according to claim 1,
wherein a speaker is disposed in the first housing, and
the speaker and the charging section are positioned not to face one another in a direction of thickness of the first housing and the second housing when the first housing and the second housing overlap one another.

7. The portable terminal according to claim 2,
wherein a speaker which outputs a sound is disposed in the first housing, and
the speaker and the charging section are positioned not to face one another in a direction of thickness of the first housing and the second housing when the first housing and the second housing overlap one another.

8. The portable terminal according to claim 1,
wherein a speaker which outputs a sound is disposed in the second housing, and
the speaker is positioned at one end of the second housing and the charging section is positioned at another end of the second housing, the one end and the another end which are opposed to one another in a direction of a surface of the second housing.

9. The portable terminal according to claim 2,
wherein a speaker is disposed in the second housing, and
the speaker is positioned at one end of the second housing and the charging section is positioned at another end of the second housing, the one end and the another end which are opposed to one another in a direction of a surface of the second housing.

10. The portable terminal according to claim 1, further comprising:
a control section that controls the communication section and the charging section,
wherein when the communication section receives an incoming call during charging by the charging section, the control section controls the charging section to stop the charging and controls to notify the incoming call.

11. The portable terminal according to claim 2, further comprising:
a control section that controls the communication section and the charging section,
wherein when the communication section receives an incoming call during charging by the charging section, the control section controls the charging section to stop the charging and controls to notify the incoming call.

12. The portable terminal according to claim 10,
wherein when the control section determines that a communication by the communication section based on the incoming call is terminated, the control section controls the charging section to resume the charging.

13. The portable terminal according to claim 11,
wherein when the control section determines that a communication by the communication section based on the incoming call is terminated, the control section controls the charging section to resume the charging.
